(19) United States
(12) Patent Application Publication
(10) Pub. No.: US 2002/0111872 A1
(43) Pub. Date: Aug. 15, 2002

(54) Real time method for dynamic packaging items for distribution

(75) Inventors: Tony Joe Brice, N. Colleyville, TX (US); Joseph Robert Offutt, Grapevine, TX (US)

Correspondence Address: FINNEGAN, HENDERSON, FARABOW, GARRETT &, DUNNER LLP, 1300 I STREET, NW, WASHINGTON, DC, 20005, US

(73) Assignee: Sabre Inc.

(21) Appl. No.: 09/779,974

(22) Filed: Feb. 9, 2001

(51) Int. Cl. G06F 17/60

(52) U.S. Cl. 705/26

(57) ABSTRACT

A method for providing information on packages of items comprising: receiving a consumer request for a set of items of interest; identifying potential providers capable of providing items that may satisfy the identified items of interest; dynamically packaging multiple items, each from a different provider selected from a database of potential providers, into a package of items; and providing information reflecting the package of items that satisfies the consumer request. The consumer is then able to accept the information provided, book the package of items with the potential providers, and purchase the packaged items. The method also provides a means for compensating the potential providers and the selling agents involved in the transaction.

### BACKGROUND OF THE INVENTION

A. Field of the Invention

This invention generally relates to a business method, and more particularly, to methods for dynamically packaging items such as products or services, for distribution or sale, incorporation of discounts and other incentives to purchase, and the compensation of selling agents for the sale of the packaged items.

B. Description of the Related Art

By using the Internet, and specifically the World Wide Web (“Web”), the ability to interface with product suppliers is simplified. The architecture of the Web follows a conventional client-server model. The terms “client” and server”are used to refer to a computer's general role as a requester of data (the client) or provider of data (the server). Under the Web environment, Web browsers reside in clients and specially formatted “Web documents” are served by Web servers. These documents may be pre-stored or generated dynamically in response to requests. Web clients and Web servers communicate using a protocol called “HyperText Transfer Protocol” (HTTP).

Currently, the Internet is being increasingly used as an avenue for business and commerce. When utilizing the Internet for purchasing various products and services, customers, through a Web browser, formulate a request for the products or services that they wish to purchase. The conventional Internet ordering systems that receive the customer requests follow the same serial approach as consumers purchasing multiple products at a store. They operate by allowing the consumer to select each product in a serial manner, product A followed by product B, and so forth, and then end the transaction by paying for all of the selected products.

One example of such a conventional electronic system is the Travelocity.com travel reservation system accessible on the Internet at www.travelocity.com. In this system, users can either select and pay for each component of a trip, e.g., airfare, hotel, car rental, etc., separately, or select multiple travel components in series and then pay for all of the components at one time. But the system suffers from a variety of limitations. First, the system does not provide travel service providers with information on travelers' fulfilled and unfulfilled demand for travel services and products. The system simply tries to match traveler demand with supplier inventory. Consequently, suppliers cannot use travel distribution services and systems like Travelocity to configure specific packages consisting of multiple components (e.g., air travel, car rental, and accommodations) that satisfy individual traveler's travel demands or the demand of a group of travelers.

Of course the same limitation on information provided to suppliers means that suppliers cannot price their products in a flexible manner such that one product is discounted in view of a purchase of the product in combination with another product. For example, a supplier or group of suppliers may be willing to discount an airfare when a traveler agrees to stay a particular hotel during his/her stay at the destination.

This lack of information leads to yet another problem with conventional electronic travel distribution systems. Because suppliers cannot effectively combine or group their products and services for sale to travelers as packages, the suppliers are unable to take advantage of any reduction in commissions paid to agents and partners that may flow from the sale of travel packages.

Accordingly, based on the deficiencies of the conventional Internet ordering systems described above, there is a need for a business method that provides Internet customers with the ability to dynamically package multiple products or services to increase their purchasing power, and provides proper compensation to the providers and/or selling agents involved in the transaction.

### SUMMARY OF THE INVENTION

Accordingly, methods consistent with the present invention obviate one or more problems of existing systems for providing suppliers the ability to dynamically generate an offer for multiple products and services, based not only on the buyers needs, wants, preferences, etc., but also based on supplier-defined parameters.

In accordance with one aspect of the present invention, as embodied and broadly described herein, a method is used for providing information relating to packages of items comprising: receiving a consumer request for a set of items of interest; identifying potential providers capable of providing items that may satisfy the identified items of interest; dynamically packaging multiple items, each from a different provider selected from the potential providers, into a package of items; and providing information reflecting the package of items in response to the request.

In accordance with another aspect of the invention, a package request processor is provided to receive a consumer request and submit a request to an item/provider database system. The item/provider database system searches a database of providers to identify potential providers of items, and provides a response containing the items and potential providers to the package request processor.

The package request processor receives the response and packages the items for the consumer. The packaging request processor may utilize a number of packaging rules to package the items based on any arrangements and agreements set in the item/provider database system.

Once the packaging request processor has packaged the items, using one or more of the packaging rules in the item/provider database, the package request processor provides a response comprised of a plurality of packages to the consumer. The consumer is then given the option to purchase a package of items.

In accordance with yet another aspect of the invention, as embodied and broadly described herein, a compensation processor is provided for receiving the response comprised of a plurality of packages from the package request processor and providing a response which exposes compensation to the selling agent. Such compensation may consist of previously negotiated commissions, visibility of override commission levels that may be attainable with additional sales, and/or selling agent markup amounts defined previously in the selling agent's markup database.

In accordance with yet another aspect of the invention, as embodied and broadly described herein, a booking engine is provided to receive a purchase request from the consumer or selling agent. The booking engine books a package of items with the selected providers by sending a booking request to the item/provider database system. Once the item/provider database system notifies each of the potential providers of the purchase request and the providers accept the purchase request, a provider confirmation response is returned to the booking engine. The booking engine then returns the provider confirmation to the consumer or selling agent to complete the transaction.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 is a state diagram illustrating a dynamic packing process according to the present invention;

FIG. 2 is a block diagram needed to explain the operation of a system consistent with the present invention;

FIG. 3 is a flow chart of the process performed by the package request processor according to the present invention;

FIG. 4 is a flow chart of the process performed by the booking processor according to the present invention; and

FIG. 5 is a flow chart of an alternate process performed by the package request processor according to the present invention.

### DETAILED DESCRIPTION

Reference will now be made in detail to an implementation consistent with the present invention as illustrated in the accompanying drawings. Wherever possible, the same reference numbers will be used throughout the drawings and the following description to refer to the same or like parts.

Introduction

Methods consistent with the present invention are implemented in a network, which provides product offers to consumers or selling agents acting on behalf of the consumer, based on discounts and other special offer parameters. The network allows consumers to identify a set of items of interest. Then, the network identifies potential providers capable of providing items that may satisfy the identified set of items. The items from the identified providers are dynamically packaged into a package of items, and the information reflecting the package of items is presented to the consumer and/or selling agent.

The consumer is then able to submit a purchase request to buy a package of items from a plurality of packages of items. In response to receiving the purchase request, the network of the present invention provides the consumer with a confirmation of the purchase, notifies each of the potential providers associated with the package, and requests a commitment from the notified potential providers to provide an item as part of the package.

The network enables providers to create and manage unique compensation structures that compensate a selling agent for submitting the consumer's request to the network and/or compensate a partner provider for supplying one or more of the items that the consumer purchased. In addition to the compensation structures created and managed by providers of the products or services, the selling agents themselves may create and manage markups that are applied to packages of items.

Dynamic Packaging Process

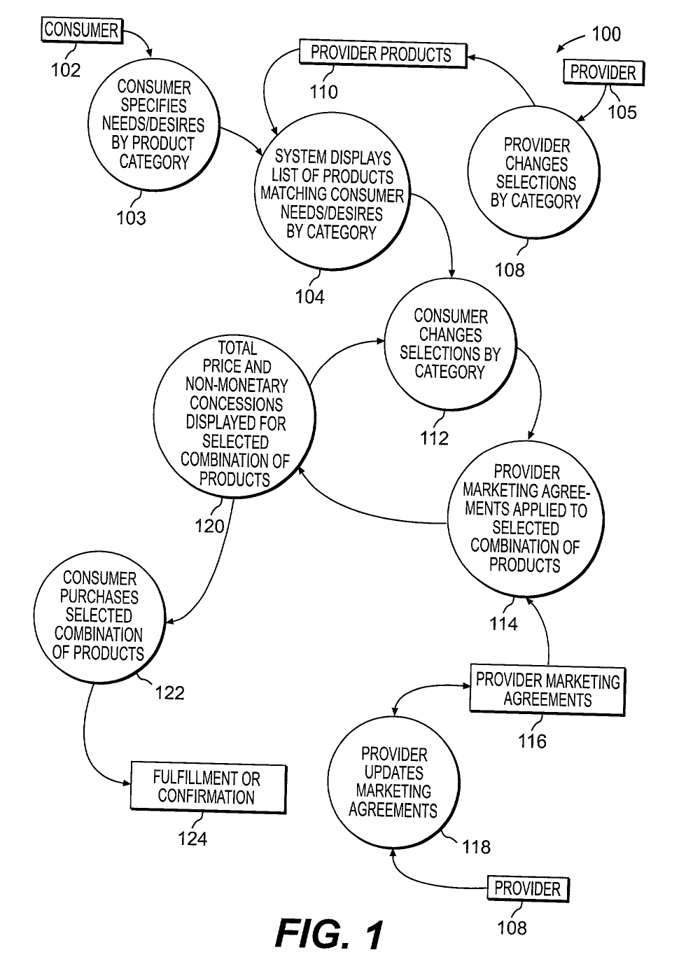

FIG. 1 is a state diagram 100 illustrating the dynamic packaging process according to one implementation consistent with the present invention. In FIG. 1, the consumer 102 begins the process by specifying, by product category, the products that are needed and desired (state 103). The network responds to the consumer by displaying, by category, the list of the products matching the shopper's needs and desires (state 104). Provider 105 may change selections in the list by category (state 108) to develop the list of products 110 that are displayed at state 104.

Once the list of products is displayed to the consumer, the consumer may change, by category, the product selections (state 112). The system then applies the supplier marketing agreements 116 to the selected combination of products (state 114). The supplier marketing agreements applied to the combination of products may be updated at the discretion of the provider (state 118).

State 120 follows state 114, and the total price and non-monetary concessions are displayed to the consumer and/or selling agent for the selected combination of products. At this state, the compensation structures are also displayed to the selling agent and/or the partner providers for the selected combination of products. The compensation structures, however, are not displayed to the consumer. At this point, the consumer must make the decision to purchase the combination of products (move to state 122) or return to state 112 and change, by category, the product selections.

If the consumer 102 decides to proceed to state 112 and change the product selections, the system again applies the supplier marketing agreements 116 to a new combination of products and returns to state 120, to display the total price and non-monetary concessions for the new selected combination of products to the consumer and/or selling agent, and display the compensation structures to the selling agents and/or partner providers.

However, if at state 120 the consumer makes the decision to purchase the combination of products (state 122), the system provides a fulfillment or confirmation of the purchase and the transaction is completed (state 124).

Network Architecture

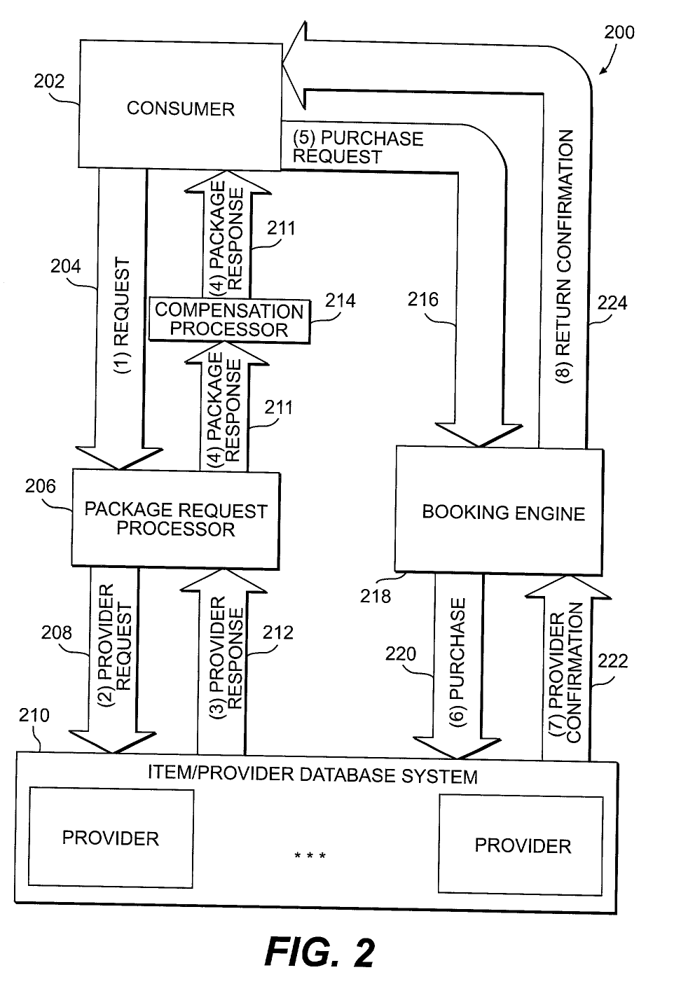

FIG. 2 illustrates a conceptual diagram of a network 200 in which the present invention may be implemented. In FIG. 2, a consumer 102 submits a request 204 to the package request processor 206. The request 204 includes the identification of a set of items, by category, that the consumer may be interested in purchasing. The package request processor 206 receives the consumer request and in turn submits a provider request 208 to an item/provider database system 210, which searches a database of providers and items, to identify potential providers for the set of items identified in the request 204, and perhaps other items of a package. After the item/provider database system 210 searches the database of providers and items, the item/provider database 210 provides a provider response 212 to the package request processor 206 identifying the items and providers.

In response to receiving the provider response 212, the package request processor 206 packages the items for presentation to the consumer 102. The packaging request processor 206 packages the items by applying a number of packing rules based on any arrangements and agreements set in the item/provider database system 210.

For example, the packaging rules that the package request processor 206 may apply could comprise: (i) combining items into the package such that the total price associated with the package is less than the sum price for all the items in the package individually; (ii) combining items into the package such that, when the package includes first and second items and the first item has a price of X alone and the second item has a price of Y alone, the total price of the package is less than the sum of X and Y, or less than the price of X alone, or less than the price of X by a predetermined percentage; (iii) combining items into the package such that, when the package includes first and second items and the first item has a price of X alone and the second item has a price of Y alone, the price of the package is less than the price of X by a percentage set by an entity handling the packaging of the first and second items; and (iv) combining items into the package such that, when the package includes first and second items and the first item has a price of X alone and the second item has a price of Y alone, the price of the package is less than the price of X by a percentage set by an arrangement between the providers of the first and second items.

Once the packaging request processor 206 has packaged the items using one or more of the packaging rules in the item/provider database system 210, the package request processor 206 provides a package response 211 to the compensation processor 214. The compensation processor 214 determines the compensation to the selling agents and the partner providers.

In one compensation structure, the selling agents incorporate their mark-up into the price for the combination of products. For example, in the absence of any commission, if an airline ticket price is $500, the hotel room price is $200 per night for two nights, and a rental car price is $100; the total price is $1,000. The selling agents automatically mark up this total by a percentage (e.g., 25%), or just add a dollar amount, for example a service fee of $50 or $100 to the transaction. Therefore, the consumer is paying a price that is not only the base price of the components, but also includes an economic surplus, i.e., profit for the selling agent who is selling the component.

In another compensation structure with commissions, the commissions are taken from the $1,000 or the total price. The difference is a matter of whether the supplier is providing the compensation within the quoted prices or if the prices are net, meaning the travel agency owes exactly that price to the provider of the service. Then, the profitability is added on top of the component price.

The compensation structure with commissions, described above, can be further described by a two-step process. The first step of the process involves managing the commission structure on a trading-partner-by-trading-partner basis. These commission structures may be fixed. It could be 10% for an entire year or it could be based on different levels with overrides introduced based on sales volume. Thus, the first step is purely the maintenance of the commission structure by the supplier, and it typically would be a percentage that was agreed with the selling agent. The second step of the process then involves the incorporation of the commission and the displaying of the total price as part of the actual package price.

In the present invention, it is also possible to provide a combination of the two compensation structures describe above. The compensation structure may include both a commission and a fixed amount that is added to the net amount of the products within the package.

Once the compensation for the selling agents and the partner providers is determined, the compensation processor 214 then transmits the package response 211 to the consumer 102. At this point, the consumer 102 may accept the package response 214 by submitting a purchase request 216 to the booking engine 218. In turn, the booking engine 218 receives the purchase request 216 and books the packaged items with the respective providers by submitting a purchase request 220 to the item/provider database system 210.

After the item/provider database system 210 receives the purchase request 216, item/provider database system 210 notifies each of the potential providers of the purchase request 216. When the providers accept the purchase request 216, the package item providers are compensated for their commitment to provide the package items and a provider confirmation 222 is returned to the booking engine 218. The booking engine 218 then in turn provides a return confirmation 224 to the consumer 102 to complete the transaction.

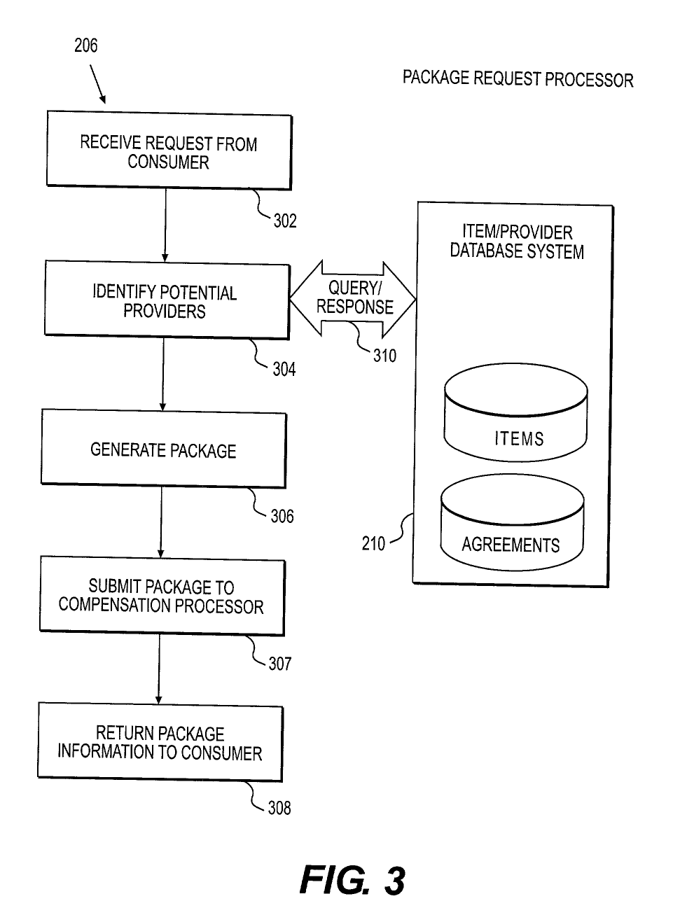

FIG. 3 depicts a flow chart showing details of the process performed by package request processor 106 of FIG. 2. In FIG. 3, the package request processor 206 receives the consumer request (step 302), including a number of items of interest. In turn, the package request processor 206 identifies the potential providers by submitting a query to an item/provider database system 210 (step 310), which searches a database of providers and items to identify the potential providers that may supply the items requested by the consumer.

After item/provider database system 210 searches the database of providers and items, the item/provider database system 210 provides a response 212 identifying the items and providers to the package request processor 206 (step 310). The package request processor 206 then generates the package of items (step 306), by considering any arrangements or agreements with the potential providers of the items that will be included in the package, and submits the package information to the compensation processor 214 (step 307). The compensation processor determines the compensation for the selling agents and the partner providers returns and then forwards the package information to the consumer (step 308).

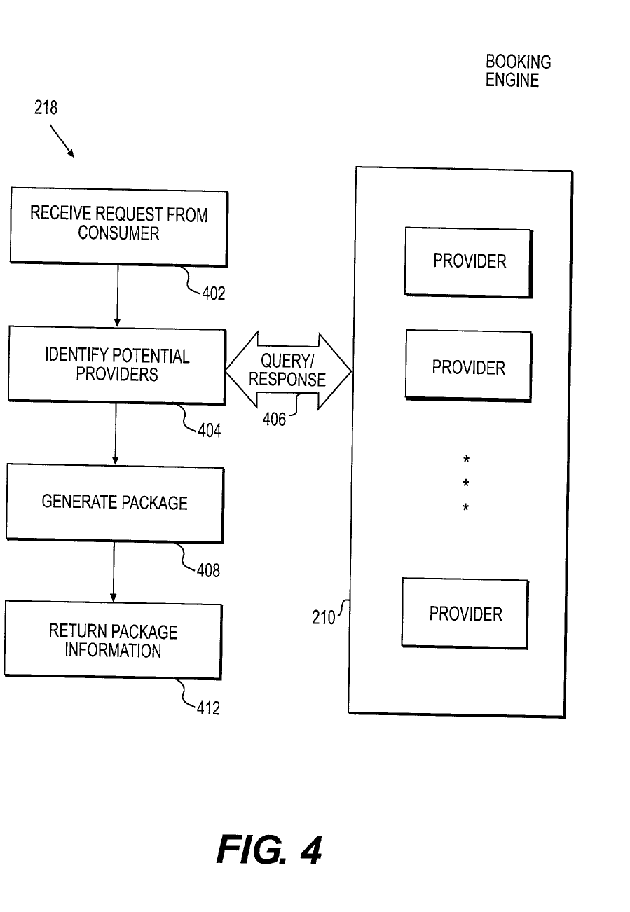

FIG. 4 depicts a flow chart of a process performed by booking engine 218 of FIG. 2. In FIG. 4, booking engine 218 receives a request from the consumer to purchase the packaged items (step 402). The booking engine 218 in response to the customer request identifies the potential providers by submitting a query to the item/provider database system 210 (step 404 and 406).

After the item/provider database system 210 receives the query, the item/provider database system 210 notifies each of the potential providers of the purchase request. When the providers accept the purchase request, the package item providers are compensated for their commitment to provide the package items and a provider confirmation response is returned to the booking engine 218. The booking engine 218 then in turn generates the package of items (step 408) and returns the package information to the consumer to complete the transaction (step 412).

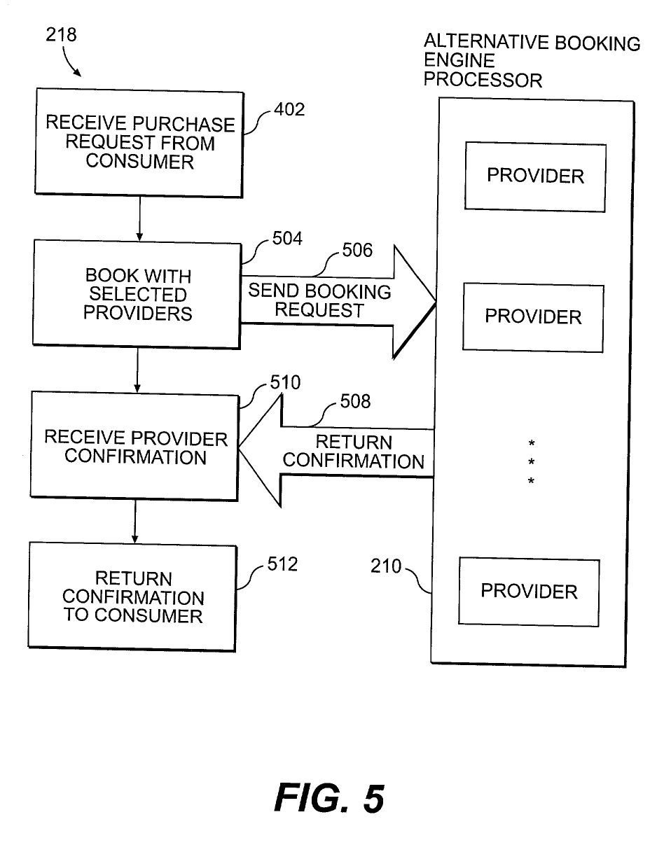

In the alternative embodiment of the booking engine 218 depicted in FIG. 5, the booking engine 218 receives a purchase request from the consumer (step 402). Then, the booking engine 218 books the package of items with the selected providers (step 504) by sending a booking request to the item/provider database system 210. Once the item/provider database system 210 notifies each of the potential providers of the purchase request and the providers accept the purchase request, the package item providers are compensated for their commitment to provide the package items and a provider confirmation response (step 508) is returned to the booking engine 218 (step 510). The booking engine 218 then returns the provider confirmation to the consumer to complete the transaction (step 512).

While the network described with respect to FIG. 2 references a network, and specifically the internet, it will be recognized by one skilled in the art that the network may be any topology, such as private networks (e.g. an intranet) and internal computer structures, that allow either various clients and/or servers within a single computer system to exchange information.

One skilled in the art will also recognize that many execution and memory schemes can be used to implement the present invention. In addition, single or multiple computer systems may also be used in the implementation of the present invention. In one embodiment, several components may be executed and contained within a single computer's memory. This memory may be RAM, ROM, other memory structure or a combination thereof. However, this invention may also be implemented using virtual memory, a secondary storage medium and/or across multiple computers. These various configuration issues relate to an implementation preference and are considered within the scope of the present invention.

CONCLUSION

The present invention comprises a method for providing consumers with information of interest about packages of items. The method identifies potential providers capable of providing items that may satisfy the identified items of interest, and dynamically packages the multiple items based upon a number of packaging rules. The consumer is then able to accept the package of items and, through a booking engine, purchase the package of items. The method of the present invention also provides a means for setting up compensation structures for compensating selling agents and the providers of the package of items.

It will be recognized by one skilled in the art that, while this description discusses the invention in terms of the packaging of items through the Internet, the scope of this invention also includes the packaging of other item that are selected from a database in private networks (e.g. an intranet) and internal computer structures, which allow either various clients and/or servers within a single computer system to exchange information.

The foregoing description of an implementation of the invention has been presented for purposes of illustration and description. It is not exhaustive and does not limit the invention to the precise form disclosed. Modifications and variations are possible in light of the above teachings or may be acquired from practicing the invention.

For example, the described implementation includes software but the present invention may be implemented as a combination of hardware and software or in hardware alone. The invention may be implemented with both object-oriented and non-object-oriented programming systems. Additionally, components of the present invention are stored in memory; one skilled in the art will appreciate that these components can be stored on other types of computer-readable media, such as secondary storage devices, like hard disks, floppy disks, or CD-ROM; a carrier wave from the Internet or other propagation medium; or other forms of RAM or ROM. The scope of the invention is defined by the claims and their equivalents.

We claim:

1. A computer-implemented method for providing information on packages of items, comprising:
receiving a request identifying an interest in a set of items;
identifying potential providers capable of providing items that may satisfy the identified interest;
packaging multiple items, each from a different provider selected from the potential providers, into a package of items; and
providing information reflecting the package of items in response to the request.

2. The method of claim 1, further comprising:
receiving a purchase request to purchase the package; and
providing a confirmation in response to the purchase request confirming the purchase of the package.

3. The method of claim 2, wherein the step of providing a confirmation in response to the purchase request confirming the purchase of the package, comprises:
notifying each of the potential providers associated with the package of items of the purchase request; and
receiving a commitment from each of the notified potential providers to provide an item as part of the package of items.

4. The method of claim 3, further comprising:
compensating each of the notified potential providers for the item provided as part of the package of items.

5. The method of claims 4, further comprising compensating one or more selling agents and notified potential provides based on a commission structure, a net structure, or a combination of a commission structure and a net structure.

6. The method of claim 1, wherein identifying potential providers capable of providing items that may satisfy the identified interest, comprises:
searching a database of providers and items provided by each provider to identify the potential providers.

7. The method of claim 1, wherein dynamically packaging multiple items, each from a different provider selected from the potential providers, into a package of items, comprises:
considering any arrangements with the potential providers to select providers for the items of the package.

8. The method of claim 1, wherein dynamically packaging multiple items, each from a different provider selected from the potential providers, into a package of items, comprises:
combining items into the package such that a total price associated with the package is less than a sum of prices for all of the items in the package individually.

9. The method of claim 1, wherein dynamically packaging multiple items, each from a different provider selected from the potential providers, into a package of items, comprises:
combining items into the package such that when the package includes first and second items and the first item has a price of X when purchased alone and the second item has a price of Y when purchased alone a total price of the package is less than a sum of X and Y.

10. The method of claim 1, wherein dynamically packaging multiple items, each from a different provider selected from the potential providers, into a package of items, comprises:
combining items into the package such that when the package includes first and second items and the first item has a price of X when purchased alone and the second item has a price of Y when purchased alone a price of the first item as part of the package is less than X.

11. The method of claim 1, wherein dynamically packaging multiple items, each from a different provider selected from the potential providers, into a package of items, comprises:
combining items into the package such that when the package includes first and second items and the first item has a price of X when purchased alone and the second item has a price of Y when purchased alone a price of the first item as part of the package is less than X by a predetermined percentage.

12. The method of claim 1, wherein dynamically packaging multiple items, each from a different provider selected from the potential providers, into a package of items, comprises:
combining items into the package such that when the package includes first and second items and the first item has a price of X when purchased alone and the second item has a price of Y when purchased alone a price of the first item as part of the package is less than X by a percentage set by an entity handling the packaging of the first and second items.

13. The method of claim 1, wherein dynamically packaging multiple items, each from a different provider selected from the potential providers, into a package of items, comprises:
combining items into the package such that when the package includes first and second items and the first item has a price of X when purchased alone and the second item has a price of Y when purchased alone a price of the first item as part of the package is less than X by a percentage set by an arrangement between providers of the first and second items.
